(19) United States
(12) Patent Application Publication
(10) Pub. No.: US 2007/0168472 A1
(43) Pub. Date: Jul. 19, 2007

(54) Call center gui: XML converter

(75) Inventor: Edward Walter, Boerne, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/334,244

(22) Filed: Jan. 18, 2006

(51) Int. Cl. G06F 15/177

(52) U.S. Cl. 709/220

(57) ABSTRACT

The present disclosure provides a system, method, and computer-readable medium for accessing a feature version at an Internet Protocol (IP) phone. An Extensible Markup Language (XML) code is activated at the IP Phone. A feature selection selected at the IP Phone is associating to a version of the feature using the activated XML code, and the associated feature version is then performed.

### BACKGROUND OF THE DISCLOSURE

1. Field of the Disclosure

The present disclosure relates to feature selection at devices within a call center.

2. Background

A call center is a centralized office that generally either answers incoming telephone calls from customers (such as for product support) or makes outgoing telephone calls to customers (such as for telemarketing). When calling a call center, a customer generally dials a single telephone number to reach a central server and is redirected to one of multiple agents (call center employees) working at the call center. Within a formal call center, agents work at workstations that include a computer and a telephone set connected to a large telecom switch and one or more supervisor stations, which may include the central server. When the central server receives a call (referred to as a “first leg” or as “Leg 1”) from a customer, the server typically obtains customer information, puts the call in a queue, and sends the obtained information to workstation computers for display on a monitor. The agent selects the call from the computer screen, often using a keyboard or mouse device, thereby enabling the central server to connect the customer to the agent. In a formal call center setting, the workstation phone is connected only to the central server. Any outside calls that the agent might like to make, such as to a family member, must be done at a separate phone that has an outside connection. Generally, if a person selects a mid-call feature, such as the ‘Hold’ feature, when using an outside line, the feature is provided by a feature server of the outside network. That same feature selected during a call center call is handled by the call center server. Different versions of the same feature (i.e., HOLD) are presented depending on the type of call (outside or call center line). The differences in these versions make integrating the features into a single phone difficult.

In an informal call center (generally used for small companies or organizations), the workstation typically includes a phone but no computer. Typically the phone used in an informal call center has an XML-enabled (Extensible Markup Language-enabled) display screen that serves the same purpose as the computer screen in a formal call center. In informal centers, the workstation phone may serve a dual purpose: 1) to answer call center calls, and 2) to serve as an outside line. As these two purposes (previously kept separate in a formal call center) are integrated into one phone, when a feature such as ‘Hold’ is selected at the phone, it is desired that the selected feature perform in a manner consistent with the line connection (external or call center).

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG. 1 illustrates an exemplary network integrating a call center using Internet Protocol (IP) with a Public Switched Telephone Network (PSTN).

FIG. 2 illustrates an exemplary IP Phone that may be used with the exemplary call center of in one aspect of the present disclosure.

FIG. 3 shows a flowchart describing using XML code at the IP Phone to select a version of a feature from an IP Phone.

FIG. 4 is a diagrammatic representation of a machine in the form of a computer system within which a set of instructions, when executed, may cause the machine to perform any one or more of the methodologies discussed herein.

### DETAILED DESCRIPTION OF THE DISCLOSURE

In view of the above, the present disclosure through one or more of its various aspects and/or embodiments is presented to provide one or more advantages, such as those noted below.

The present disclosure provides a method for accessing a feature version at an Internet Protocol (IP) phone. The method includes activating an Extensible Markup Language (XML) code at the IP Phone; selecting a feature selection at the IP Phone; associating the feature selection at the IP Phone to a version of the feature through the activated XML code; and performing the associated feature version. The feature version generally includes one of: a mid-call feature, and a supervisor feature. In one aspect, the XML code is activated based on a calling party. One such calling party may be a call center server. In another aspect, the XML code is activated from an XML application running at a network device. The XML application further converts information into a format displayable at the IP Phone. In another aspect of the disclosure, associating the feature selection includes directing a signal to a server that provides the associated version of the feature. Versions of a feature may be provided at multiple servers.

The disclosure further provides a computer-readable medium containing a set of instructions operative to cause a processor to execute a method which includes activating an Extensible Markup Language (XML) code at an IP Phone; selecting a feature selection at the IP Phone; associating the feature selection at the IP Phone to a version of the feature through the activated XML code; and performing the associated feature version. Features include one of a mid-call feature and a supervisor feature. In one aspect, the XML code is activated based on a calling party. One such calling party is a call center server. In another aspect, the XML code is activated from an XML application running at a network device. The XML application also converts information into a format displayable at the IP Phone. Associating the feature selection includes directing a signal to a server providing the associated version of the feature. Feature versions may be provided at multiple servers.

The present disclosure further provides a call center system that includes: a call center server for managing calls to the call center and call center features; an Extensible Markup Language (XML) server linked to the call center server for converting call center features for XML-enabled devices at the call center; and an IP phone linked to the call center server and to the XML server that associates a feature selected at the IP Phone to a call center feature using (XML) code. In one aspect, the XML code at the IP Phone is activated based on a calling party. One such calling party may be the call center server. In one aspect of the system, associating the feature selection further comprises directing a signal to a server providing the associated feature.

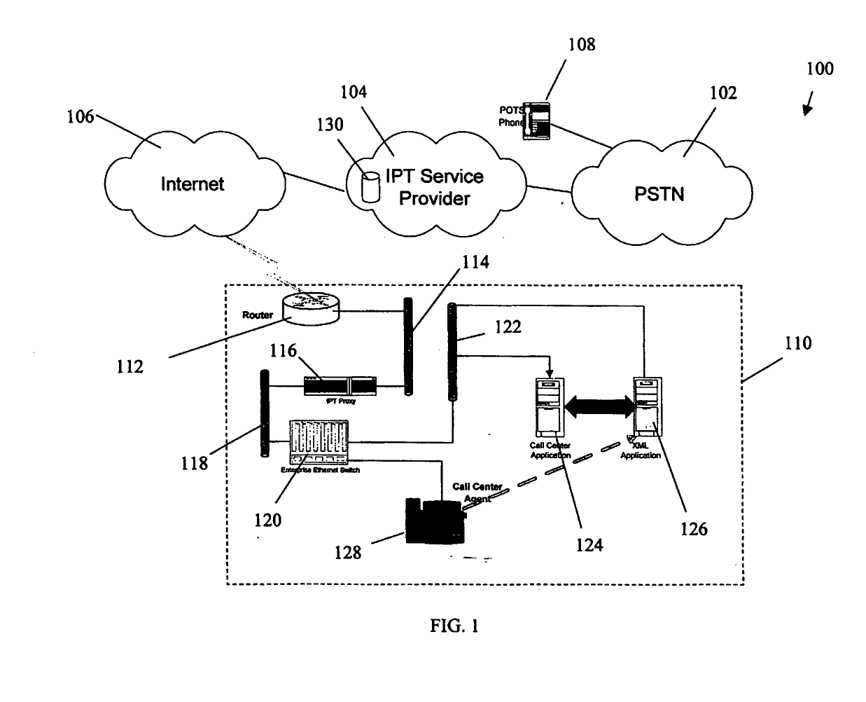

FIG. 1 illustrates an exemplary network 100 integrating a call center using Internet Protocol (IP) with a Public Switched Telephone Network (PSTN) 102. The exemplary network includes an Internet Protocol Telephone Service Provider (IPT Service Provider) 104 for providing IP-based communication and features, a PSTN 102 for enabling circuit-switched telecommunications, and the Internet 106 for transferring voice-related packets to IP-based devices using packet-switching technology. The Public Switched Telephone Network (PSTN) 102 provides local and long distance telephone connections for multiple customers using a phone using Plain Old Telephone Service (POTS), such as exemplary POTS phone 108. The IPT Service Provider 104 integrates the PSTN with the packet-switched network (e.g., Internet) and enables call signals to be transferred between both networks. The IPT Server Provider 104 also provides various mid-call features (such as ‘Hold,’ ‘Transfer,’ ‘Conference’ etc.) through a Feature Server 130 that may be used with a call signal traversing the packet-switched network. One example of an IPT Service Provider is the Hosted Internet Protocol Communication Service (HIPCS) provided by SBC Internet Services, Inc. In another aspect, it is possible to call the IPT Service Provider 104 using an Internet Protocol phone (IP Phone) without utilizing the PSTN 102. An IP Phone is a phone that communicates directly with a packet-switching network. When an IP Phone is used, the POTS phone 108 is not used and the integration capabilities of the IPT Service Provider 104 are not utilized. The Internet 106 transmits signals between IP-based entities, such as between the IPT Service Provider 104 and an IP-based Call Center 110. Voice signals are transmitted over the Internet using an appropriate protocol, such as Voice over Internet Protocol (VoIP). The exemplary network 100 further includes an IP-based call center 110 connected to the Internet 106 over a physical link such as a Digital Signal 3 (DS-3) link that sends and/or receives multiple calls. One example of a call center may be a customer service center that has multiple phones manned by multiple call agents reachable by calling a single telephone number.

The call center 110 includes various devices that systematically route multiple incoming customer calls to available agents located at various workstations. These devices include server such as a Call Center Application Server 124 for connecting calls and providing call center features to the IP phones; an XML (Extensible Markup Language) Application Server 126 for providing an XML capabilities to XML-enabled IP Phones; and one or more IP Phones, such as IP Phone 200, that are used by call center agents when responding to customer calls. The Call Center further includes a customer edge router 112 for directing calls between the call center and the Internet 106, a Proxy 116 for connecting multiple call center devices having multiple addresses internal to the call center to an IP network under a unique global IP address, an Ethernet Switch 120 for directing Ethernet traffic at the call center to selected call center devices, and various Ethernet cables 114, 118, and 122. In an alternate aspect, a device at the IPT Service Provider serving the same purpose as the Proxy 116 may be used instead of the Proxy.

The Call Center Application Server 124 runs an application that provides various call functions. In one aspect, the application of the Call Center Application Server terminates customer calls and obtains information from the customer. In another aspect, the application connects customer calls to agents at multiple IP Phones. The application tracks agent availability and links the customer to available agents. The application links customer to agent by calling the available agent and bridging the two legs of the call (the customer's call to the server and the server's call to the agents) once the agent answers the call. In yet another aspect, the application of the Call Center Application Server 124 formats the caller information for display at a Graphic User Interface (GUI) such as is used at a computer monitor. In yet another aspect, the Call Center Application Server 124 provides mid-call features, such as a ‘Hold’ feature for placing a customer on hold, a ‘Transfer’ feature for transferring a customer to another agent, and a ‘Conference’ feature for including another agent in the call, etc.

Both the IPT Service Provider 104 and the Call Center Application Server 124 provide these features capabilities at the IP Phone. However, some versions of these mid-call features depend on the source of the feature. For example, when the Transfer feature is selected through the Call Center Application Server 124, the call is tracked at the server and drop a down box with options of where to transfer the call may be provided. The same Transfer feature selected through the Feature Server 130 of the IPT Service Provider 104 does not provide call tracking nor the drop down box capabilities.

The XML Server provides an application for that provides XML conversion of the information obtained at the Call Center Application Server 124 to a format that is displayable at an XML-enabled device, such as an LCD display screen of an IP Phone. The XML application may be run on an XML Application Server 126 or alternately may operate on a processor running at a place within the network, for example, at the IPT Service Provider 104. The XML Server 126 also provides specific call center functions such as a monitoring capability at supervisor phones.

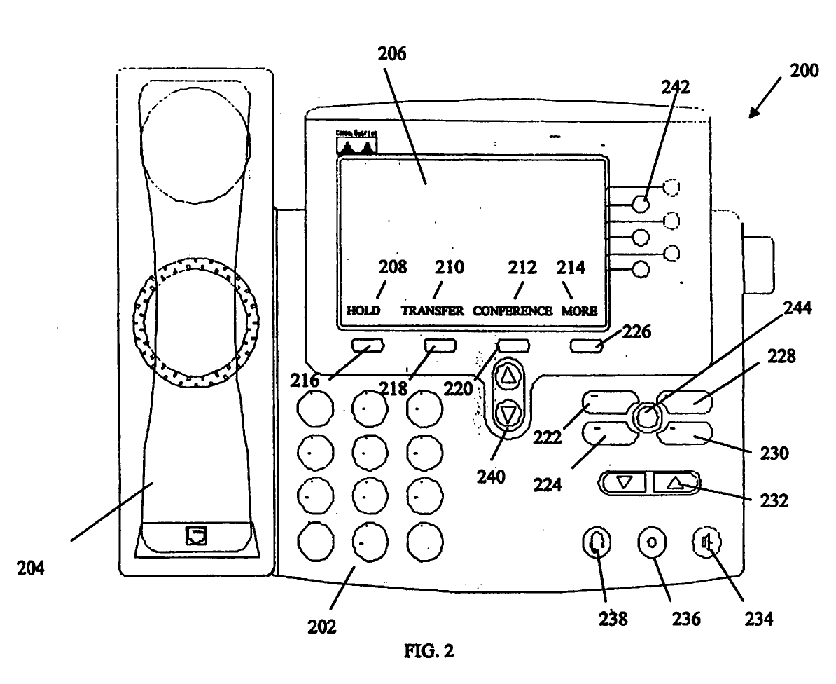

FIG. 2 illustrates an exemplary IP Phone 200 that may be used with the exemplary call center of FIG. 1 in one aspect of the present disclosure. One example of an IP Phone 200 may be a 7960 IP Phone of Cisco Systems. The IP Phone 200 includes a keypad 202 for dialing, a handset 204 for talking and listening, and an LCD display screen 206 for displaying information. A person may pick up a phone call by several methods, including picking up the handset, activating a headset, that may be plugged into the IP Phone or pushing a speakerphone button. The graphic capability of the display allow for the inclusion of such features as XML (Extensible Markup Language) and other features. An agent may indicate a customer selection by pressing a button 242 that corresponds to caller information shown on the LCD display screen. A navigator 240 may be used to browse information displayed on the LCD display screen. Buttons are also supplied which enable an agent to access various additional features, such as accessing phone messages (222), calling up a directory (228) of incoming messages, for example, changing various phone settings (230) such as the type of ring of the phone or the contrast at the display screen, and obtaining news shorts (224) such as weather, stock tickers, etc. A help button 244 is also provided to aid users of the phone. Toggle buttons are supplied which toggle the speakerphone on and off (234), toggle a mute feature on and off (236) and toggles a connectable headset apparatus on and off (238). A volume button (232) increases or decreases volume for the handset, headset, or speakerphone and helps adjust ringer volume and LCD display contrast.

The display screen 206 presents information that is formatted using XML as a markup language. In one aspect, at the beginning of a call, the display screen displays caller information (such as “John Doe” and “DSL problem”) related to calls waiting in the queue at the cell center application. The call may be answered by selecting a corresponding button (242). In another aspect, during a call, the display screen 206 presents various features that may be used during the call (“mid-call features”), such as ‘Hold’ 208 for putting a call on hold, ‘Transfer’ 210 for transferring a call to another agent, and ‘Conference’ 212 for setting up a conference with another agent. A ‘more . . . ’ option 214 is available to access additional features. These features may be accessed by pushing the corresponding buttons. For example, the agent may select ‘Hold’ by pushing button 216, select ‘Transfer’ by pushing button 218, select ‘Conference’ by pushing button 220, and select more options by pushing button 222.

As used with the present disclosure, the IP Phone 200 may have multiple phone numbers associated with it. For example, one phone number is generally used within the call center for exclusive use by the Call Center Application Server 124. A second phone number may be used as an outside line to make and receive calls not related to the business of the call center, such as a call to and from a business associate or family member. The present disclosure enables a mid-call feature to be routed depending on the line connection. When used as an outside line, selecting a feature such as ‘Hold’ routes the feature to the Feature Server 130 of the IPT Service Provider 104 of FIG. 1. When the call is from the Call Center Application Server 124, the feature selection may be routed to the Call Center Application Server 124.

The two legs of an exemplary path for a call between a customer and an agent that traverses a call center server in one aspect of the present disclosure is discussed with respect to FIG. 1. The exemplary call begins when a customer dials the call center from POTS phone 108. An SIP initiation message is routed across the PSTN 102 to the IPT Service Provider 104 that converts the signal to packets for transmission over a packet-switched network. The packets are routed across the Internet 106 using an appropriate protocol, such as VoIP, to the call center. At the call center, the signal traverses multiple devices, such as router 112, the proxy 116, and the Ethernet switch 120 to terminate at the Call Center Application Server 124. The call center terminates the call and establishes a Realtime Transport Protocol (RTP) stream (“Leg 1”) for voice transfer.

Once the first leg is established, an information gathering session generally ensues between the Call Center Application Server 124 and the customer to obtain customer information, such as name (“John Doe”) and caller concern (“DSL not working”). After gathering customer information, the application of the Call Center Application Server 124 may place the customer in queue. The application then determines availability of agents using an appropriate routing method, such as “Skills-based routing” which matches the special knowledge of the agent with the specific needs of the customer. Once the Call Center Application of the Call Center Application Server 124 obtains the customer information, the XML Application of the XML Application Server 126 collects the information from the Call Center Application, formats the information using XML, and forwards the XML information to the XML-enabled LCD screen on the IP Phone 200. An agent at the IP Phone 200 accepts the call by pushing a corresponding button on the IP Phone. When the call is selected, a signal is sent from the XML Application to the Call Center Application. The Call Center Application then initiates a second leg (“Leg 2”).

The Call Center Application Server 124 initiates Leg 2 by sending a Session Initiation Protocol (SIP) invite destined for the Feature Server 130 on the IPT Service Provider 104. The SIP flows across the Ethernet Switch 120, the IPT Proxy 116, and the Router 112 through Internet 106 to the IPT Service Provider 104. The IPT Service Provider 104 sends the message back across the Internet 106, the Router 112, the IPT Proxy 116, and the Ethernet Switch 120 and is routed to the IP Phone 200. When the agent answers the call at the IP phone, the call center Application bridges Leg 1 and Leg 2 to establish a connection between the customer and the call center agent. Thus, an RTP stream is connected from the POTS Phone 108 through the Call Center Application Server 124 to the Agent's IP Phone 200. Through XML code activated at the IP Phone, mid-call features, such as ‘Hold,’ ‘Transfer,’ ‘Conference,’ etc., that are selected at the IP Phone during the call are associated with versions of the features provided at the Call Center Application Server 124.

An exemplary path of a call received at the IP Phone of the call center without traversing the call center server is discussed with reference to FIG. 1. The exemplary call begins when a customer dials the call center from POTS phone 108. An SIP initiation message is routed across the PSTN 102 to the IPT Service Provider 104 that converts the signal to packets for transmission over a packet-switched network. The packets are routed across the Internet 106 using an appropriate protocol, such as VoIP, to the call center. At the call center, the signal traverses multiple devices, such as router 112, the Proxy 116, and the Ethernet switch 120 to terminate at the IP Phone 200. Once the agent answers the call, a Realtime Transport Protocol (RTP) stream is set up between the caller and the agent. The mid-call features, such as ‘Hold,’ ‘Transfer,’ ‘Conference,’ etc., that are selected at the IP Phone during the call are associated with versions of the features provided at the Feature Server 130 of the IPT Service Provider 104.

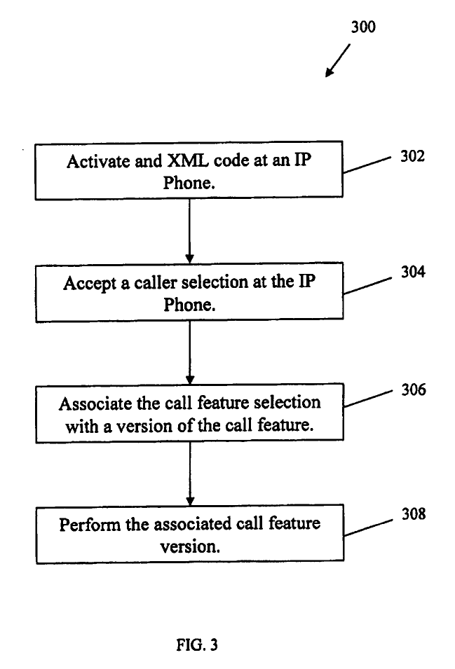

FIG. 3 shows a flowchart describing using XML code at the IP Phone 200 to select a version of a feature from an IP Phone. In Box 302, XML code is activated at the IP Phone. In one aspect, the XML code is activated based on a calling party. For example, a call originating from the call center server may indicate to the XML code to associate the feature selection to a mid-call feature version at the Call Center Application Server 124, and a call that passes through the network server but does traverse a Call Center Application Server may not activate the XML code. The XML code may be activated from the XML Server 126. In Box 304, the agent at the IP Phone selects a feature selection from an agent at the IP Phone. Features are displayed at the LCD screen 206 and the agent may select a given feature by pushing a button corresponding to the feature, for example. The feature selection is then associated with a version of the mid-call feature using XML code (Box 306). For example, with the XML code activated, the feature selection may be associated to a feature version at the Call Center Application Server 124, and when the XML code is not activated, the IP Phone 200 associates the feature selection to a feature version at the Feature server 130 of the IPT Service Provider 104. Once the association is made and the feature selected, a signal is sent to the server providing the associated version of the feature. In Box 308, the associated feature is performed at the server that provides the feature.

In another aspect of the disclosure, supervisor features, such as supervisor monitoring, may be provided at the IP Phone using XML code. The XML Server generally provides supervisor capabilities to a designated supervisor phone. A supervisor may select a key at the IP Phone and either scroll through a list of available agents or select an agent by typing in an extension. The supervisor may then monitor an agent's progress with disrupting activity at the agent workstation. In another aspect of the disclosure, the XML server converts screen items usually provided through a GUI at a PC monitor for display on the display screen of the IP Phone.

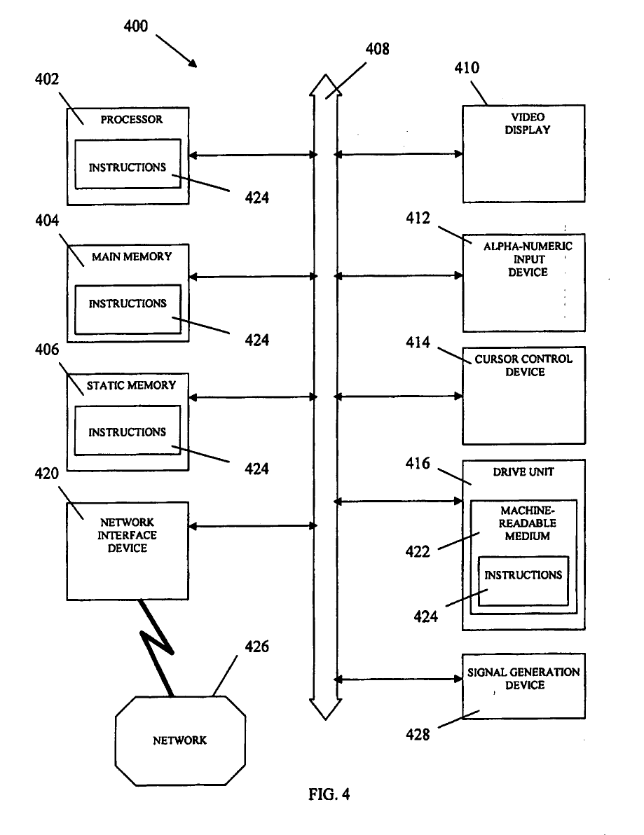

FIG. 4 is a diagrammatic representation of a machine in the form of a computer system 400 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium containing a set of instructions operative to cause a processor to execute a method, the method comprising:
activating an Extensible Markup Language (XML) code at an IP Phone;
selecting a feature selection at the IP Phone;
associating the feature selection at the IP Phone to a version of the feature through the activated XML code; and
performing the associated feature version.

2. The computer-readable medium of claim 1, wherein the feature is selected from one of a mid-call feature and a supervisor feature.

3. The computer-readable medium of claim 1, wherein the XML code is activated based on a calling party.

4. The computer-readable medium of claim 3, wherein the calling party is a call center server.

5. The computer-readable medium of claim 1, wherein the XML code is activated from an XML application running at a network device.

6. The computer-readable medium of claim 5, wherein the XML application converts information into a format displayable at the IP Phone.

7. The computer-readable medium of claim 1, wherein associating the feature selection further comprises directing a signal to a server providing the associated version of the feature.

8. The computer-readable medium of claim 1, wherein feature versions are provided at multiple servers.

9. A method for accessing a feature version at an Internet Protocol (IP) phone, comprising:
activating an Extensible Markup Language (XML) code at the IP Phone;
selecting a feature selection at the IP Phone;
associating the feature selection at the IP Phone to a version of the feature through the activated XML code; and
performing the associated feature version.

10. The method of claim 9, wherein the feature is selected from one of a mid-call feature and a supervisor feature.

11. The method of claim 9, wherein the XML code is activated based on a calling party.

12. The method of claim 11, wherein the calling party is a call center server.

13. The method of claim 9, wherein the XML code is activated from an XML application running at a network device.

14. The method of claim 13, wherein the XML application converts information into a format displayable at the IP Phone.

15. The method of claim 9, wherein associating the feature selection further comprises directing a signal to a server providing the associated version of the feature.

16. The method of claim 9, wherein feature versions are provided at multiple servers.

17. A call center system, comprising:
a call center server for managing calls to the call center and call center features;
an Extensible Markup Language (XML) server linked to the call center server for converting call center features for XML-enabled devices at the call center; and
an IP phone linked to the call center server and to the XML server that associates a feature selected at the IP Phone to a call center feature using (XML) code.

18. The system of claim 17, wherein the XML code at the IP Phone is activated based on a calling party.

19. The system of claim 18, wherein the calling party is the call center server.

20. The system of claim 17, wherein associating the feature selection further comprises directing a signal to a server providing the associated feature.
